(19) United States
(12) Patent Application Publication
(10) Pub. No.: US 2018/0015605 A1
(43) Pub. Date: Jan. 18, 2018

(54) Ratcheting Wrench Assembly

(71) Applicant: James Caesius, Kansas City, KS (US)

(72) Inventor: James Caesius, Kansas City, KS (US)

(21) Appl. No.: 15/211,677

(22) Filed: Jul. 15, 2016

(51) Int. Cl. B25G 1/00; B25B 13/46

(52) U.S. Cl. CPC B25G 1/005; B25B 13/461

(57) ABSTRACT

A ratcheting wrench assembly for tightening and loosening nuts and bolts includes a wrench that may be manipulated. The wrench has a pair of handles and each of the handles may be gripped. A ratchet is provided. The ratchet is movably coupled to the wrench. The ratchet may engage a socket thereby facilitating the wrench to rotate the socket.

### BACKGROUND OF THE DISCLOSURE

### Field of the Disclosure

The disclosure relates to wrench devices and more particularly pertains to a new wrench device for tightening and loosening nuts and bolts.

### SUMMARY OF THE DISCLOSURE

An embodiment of the disclosure meets the needs presented above by generally comprising a wrench that may be manipulated. The wrench has a pair of handles and each of the handles may be gripped. A ratchet is provided. The ratchet is movably coupled to the wrench. The ratchet may engage a socket thereby facilitating the wrench to rotate the socket.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a ratcheting wrench assembly according to an embodiment of the disclosure.

FIG. 2 is a bottom perspective view of an embodiment of the disclosure.

FIG. 3 is a right side view of an embodiment of the disclosure.

FIG. 4 is a front view of an embodiment of the disclosure.

FIG. 5 is a top view of an embodiment of the disclosure.

### DESCRIPTION OF THE PREFERRED EMBODIMENT

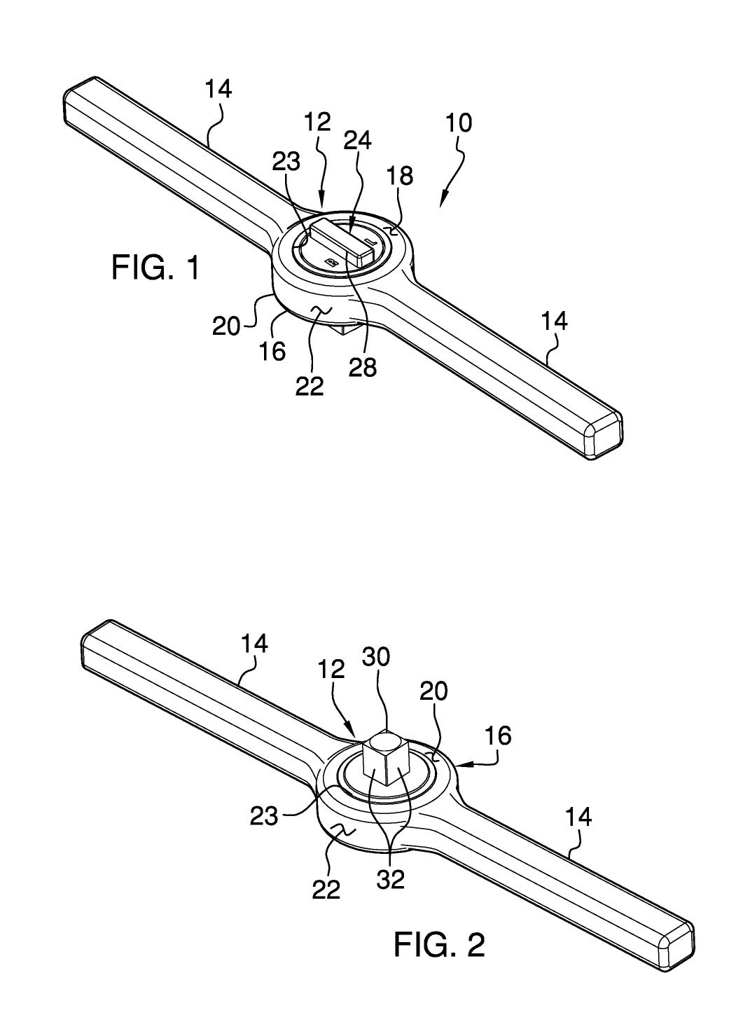

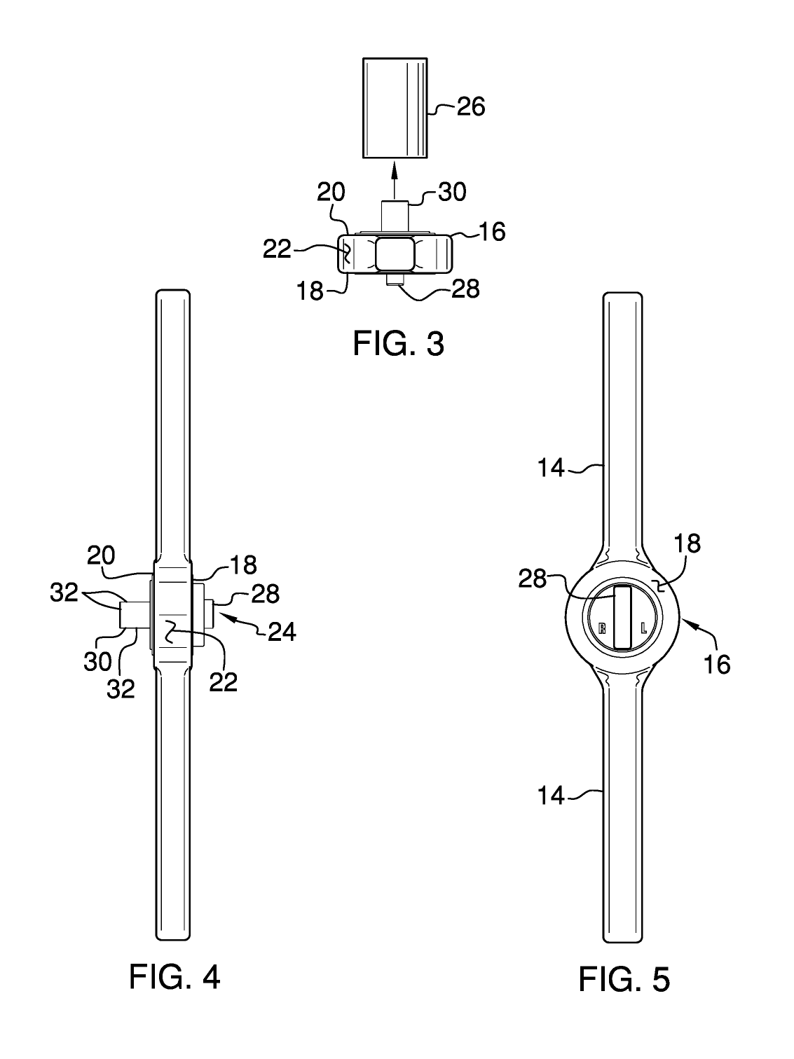

With reference now to the drawings, and in particular to FIGS. 1 through 5 thereof, a new wrench device embodying the principles and concepts of an embodiment of the disclosure and generally designated by the reference numeral 10 will be described.

As best illustrated in FIGS. 1 through 5, the ratcheting wrench assembly 10 generally comprises a wrench 12 that may be manipulated. The wrench 12 has a pair of handles 14. Each of the handles 14 may be gripped. The wrench 12 is comprised of a metallic material.

The wrench 12 comprises a central hub 16. The central hub 16 has a top surface 18, a bottom surface 20 and a peripheral surface 22 extending therebetween. The peripheral surface 22 is continuous such that the central hub 16 has a circular shape. The central hub 16 has an opening 23 extending through the top surface 18 and the bottom surface 20.

Each of the handles 14 extends away from the peripheral surface 22. Each of the handles 14 is offset one hundred eight degrees with respect to each other. Thus, each of the handles 14 enhances applying rotational torque to the central hub 16. Additionally, each of the handles 14 enhances stability of the wrench 12 when the handles 14 are gripped.

A ratchet 24 is provided. The ratchet 24 is movably coupled to the wrench 12. Thus, the ratchet 24 may engage a socket 26 thereby facilitating the wrench 12 to rotate the socket 26. The socket 26 may comprise a socket 26 wrench 12 or the like. Moreover, the socket 26 may engage a bolt or the like.

The ratchet 24 comprises a knob 28. The knob 28 is rotatably positioned within the central hub 16. The knob 28 may be manipulated between a tightening position and a loosening position. The knob 28 is positioned on the top surface 18 of the central hub 16. Additionally, the knob 28 may extend laterally across the opening 23. The ratchet 24 may comprise a socket wrench ratchet or the like.

A tab 30 is provided. The tab 30 extends downwardly from the bottom surface 20 of the central hub 16. The tab 30 has a plurality of intersecting sides 32. Thus, the tab 30 has a cubic shape and the tab 30 may engage the socket 26. Each of the intersecting sides 32 may have a width ranging between one quarter inch and one half inch.

The tab 30 is urged to rotate in a first direction when the knob 28 is positioned in the tightening position. The central hub 16 may be freely rotated in a second direction when the knob 28 is positioned in the tightening position. The tab 30 is urged to rotate in a second direction when the knob 28 is positioned in a loosening position. The central hub 16 may be freely rotated in the first direction when the knob 28 is positioned in the tightening position.

In use, the knob 28 is manipulated into the first position and each of the handles 14 is gripped. The wrench 12 is rotated about an axis extending through the top surface 18 and the bottom surface 20 of the central hub 16. Thus, the socket 26 tightens the bolt. The knob 28 is manipulated into the second position. Each of the handles 14 is gripped and the wrench 12 is rotated about the axis. Thus, the socket 26 loosens the bolt. The pair of handles 14 enhances the stability of the wrench 12 about the axis. Additionally, the pair of handles 14 enhances rotational torque to be applied to the socket 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A ratcheting wrench assembly comprising:
a wrench being configured to be manipulated, said wrench having a pair of handles wherein each of said handles is configured to be gripped, said wrench including a central hub having a top surface, a bottom surface and a peripheral surface extending therebetween, said peripheral surface being continuous such that said central hub has a circular shape, said central hub having an opening extending through said top surface and said bottom surface, each of said handles being an integral extension from said peripheral surface of said hub wherein each of said handles is in a fixed position relative to said hub and each other, each of said handles being elongated and having a substantially square shape transverse to a longitudinal axis of said handle, said square shape having rounded corners; and
a ratchet being movably coupled to said wrench wherein said ratchet is configured to engage a socket thereby facilitating said wrench to rotate the socket.

2. (canceled)

3. The assembly according to claim 1, wherein each of said handles extends away from said peripheral surface, each of said handles being offset one hundred eighty degrees with respect to each other wherein each of said handles is configured to enhance applying rotational torque to said central hub.

4. The assembly according to claim 1, wherein said ratchet comprises a knob being rotatably positioned within said central hub wherein said knob is configured to be manipulated, said knob being positioned on said top surface of said central hub.

5. The assembly according to claim 4, further comprising a tab extending downwardly from said bottom surface of said central hub wherein said tab is configured to engage the socket, said tab being urged to rotate in a first direction when said knob is positioned in a tightening position, said tab being urged to rotate in a second direction when said knob is positioned in a loosening position.

6. A ratcheting wrench assembly comprising:
a wrench being configured to be manipulated, said wrench having a pair of handles wherein each of said handles is configured to be gripped, said wrench comprising:
a central hub having a top surface, a bottom surface and a peripheral surface extending therebetween, said peripheral surface being continuous such that said central hub has a circular shape, said central hub having an opening extending through said top surface and said bottom surface, and
each of said handles being an integral extension from said peripheral surface of said hub wherein each of said handles is in a fixed position relative to said hub and each other, each of said handles being offset one hundred eighty degrees with respect to each other wherein each of said handles is configured to enhance applying rotational torque to said central hub, each of said handles being elongated and having a substantially square shape transverse to a longitudinal axis of said handle, said square shape having rounded corners; and
a ratchet being movably coupled to said wrench wherein said ratchet is configured to engage a socket thereby facilitating said wrench to rotate the socket, said ratchet comprising:
a knob being rotatably positioned within said central hub wherein said knob is configured to be manipulated, said knob being positioned on said top surface of said central hub, and
a tab extending downwardly from said bottom surface of said central hub wherein said tab is configured to engage the socket, said tab being urged to rotate in a first direction when said knob is positioned in a tightening position, said tab being urged to rotate in a second direction when said knob is positioned in a loosening position.
